(19) United States
(12) Patent Application Publication
(10) Pub. No.: US 2012/0275158 A1
(43) Pub. Date: Nov. 1, 2012

(54) DRAPE WITH MOVABLE LIGHT SOURCES

(76) Inventor: Wei-Cheng YEH, Gangshan Township (TW)

(21) Appl. No.: 13/312,034

(22) Filed: Dec. 6, 2011

(30) Foreign Application Priority Data
Apr. 29, 2011 (TW) 100207665

(51) Int. Cl. F21V 21/14

(52) U.S. Cl. 362/249.11

(57) ABSTRACT

A drape with movable light sources mainly includes a light system and a partition disposed within a bracket. The light system has a light source respectively disposed in each first moving member of the drape. A first connecting unit disposed on each first moving member is pervious to light of the light source. Dragging the first moving member brings about a synchronic movement of the light source. Namely, either drawing or expanding the drape allows each first moving member to be restrained by the partition, so that the first moving member is able to be accurately positioned on the bracket of the drape. Therefore, the movement of the light source synchronizes with the movement of the first moving member to provide an even and enhanced lighting effect. When the light source is served at darkness or night, using convenience is further achieved.

### BACKGROUND OF THE INVENTION

1. Field of the Invention

The present invention relates to a drape, particular to a drape with movable light sources.

2. Description of the Related Art

Referring to FIG. 1, a conventional drape 1 has a bracket 11, a plurality of light sources 12 equidistantly fixed on the bracket 11, a transmitting member 13 disposed on the bracket 11, at least one moving member 14 motivated by the transmitting member 13, and a covering panel 15 disposed on the moving member. Wherein, the transmitting member 13 adopts a ball chain that allows the moving members 14 to travel thereon. Further, the covering panel 15 includes a movable frame 151, and a panel body 152 disposed on the movable frame 151. The movable frame 151 is clipped by any two moving members 14 so as to be either collapsed or expanded accordingly.

In operation, users pull the transmitting member 13 manually, thereby moving the moving members 14 and accordingly expanding the covering panel 15. Namely, the moving members 14 are gradually and equidistantly positioned in time of expanding the covering panel 15. Concurrently, the movable frame 151 is synchronically unfolded by the motivation of the moving members 14. As a result, the covering panel 15 is able to sequentially spread out. Herein, the light source 12 provides light on the covering panel 15 and then illuminates.

However, in the practice, the light source 12 is fixed to the bracket 11; moreover, the transmitting member 13 is pulled manually. Herein, the manual pulling readily results in a transmission error occurred on the moving member 14, which thence cannot stop at a desired position. Accordingly, the expansion of the covering panel 15 becomes inaccurate, and the light source 12 is not juxtaposed to a middle of the movable frame 151. Therefore, the light source 12 is unable to provide thorough and consistent illumination (as shown in FIG. 2). As a result, the lighting performance of the drape is unsatisfactory.

### SUMMARY OF THE INVENTION

Therefore, the object of the present invention is to provide a drape with movable light sources by synchronically moving the light sources to achieve a precise disposition of the light sources as well as constant illumination.

The drape with movable light sources in accordance with the present invention mainly provides with a bracket, a transmitting member disposed on the bracket, at least one first moving member triggered by the transmitting member, and a covering panel installed on the first moving member. Each first moving member has a first transmitting body formed with a first receiving slot and capable of moving within the bracket, and a first connecting unit extended from the first receiving slot. Characterized in that, a light system and a partition are disposed in the bracket. The partition drives the first moving members to move in equidistance so as to allow the first moving members to be constrained thereby and positioned within the bracket. The light system has a light source disposed in each first receiving slot of the first moving member, and a connecting wire connected to the light source for electrifying. The first connecting unit is pervious to light of the light source, and the light source is synchronically moved along with the first moving member.

Preferably, a second moving member is disposed between any two first moving members; the second moving member is departed from the covering panel and has a second transmitting body defined with a second receiving slot and capable of moving within the bracket, and a second connecting unit extended from the second receiving slot; the light source is installed in the second receiving slot, and the second connecting unit is pervious to light of the light source.

Preferably, the first connecting unit is formed with a hook for hanging the covering panel.

Preferably, the first connecting unit is formed with a claw for grasping the covering panel.

Preferably, the covering panel includes a frame and a panel body fastened to a periphery of the frame; clipped by any two first moving members, the frame is expanded, allowing the second moving member to be justly positioned in a middle of the panel body.

Accordingly, disposed on the first moving member, the light source is synchronically moved while the first moving member is motivated. Moreover, the concurrent movements of the light source and the moving member allow the light source to provide thorough illumination. When the light source is served as a night light, a further using convenience is preferably obtainable.

The advantages of the present invention would be apparent in following embodiments with drawings, and like elements are denoted by same numerals throughout the disclosure.

### BRIEF DESCRIPTION OF THE DRAWINGS

FIG. 1 is a perspective view showing a conventional invention;

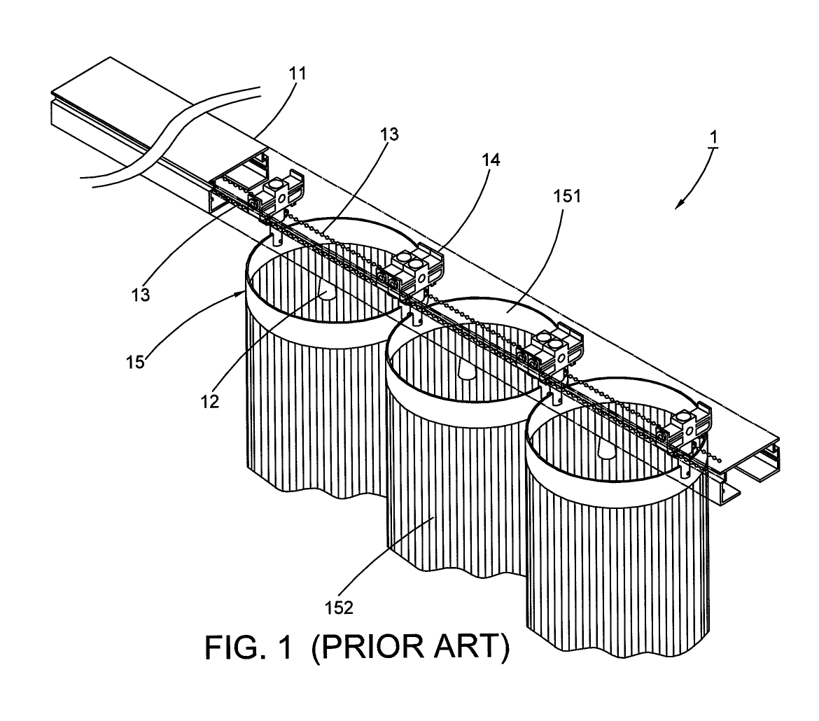

FIG. 2 is a schematic view showing the conventional invention in operation;

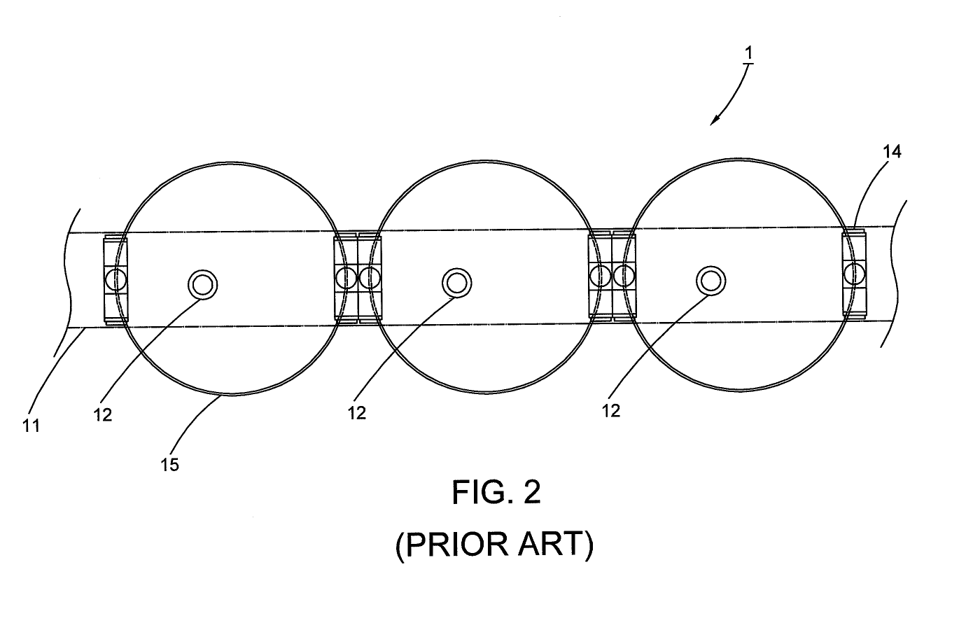

FIG. 3 a perspective view showing a first preferred embodiment of the present invention;

FIG. 4 is another perspective view showing the first preferred embodiment of the present invention;

FIG. 5 is a partially cross-sectional view showing the first embodiment;

FIG. 6 is a perspective view showing a second preferred embodiment of the present invention; and

FIG. 7 is another perspective view showing the second preferred embodiment of the present invention.

### DETAILED DESCRIPTION OF THE PREFERRED EMBODIMENTS

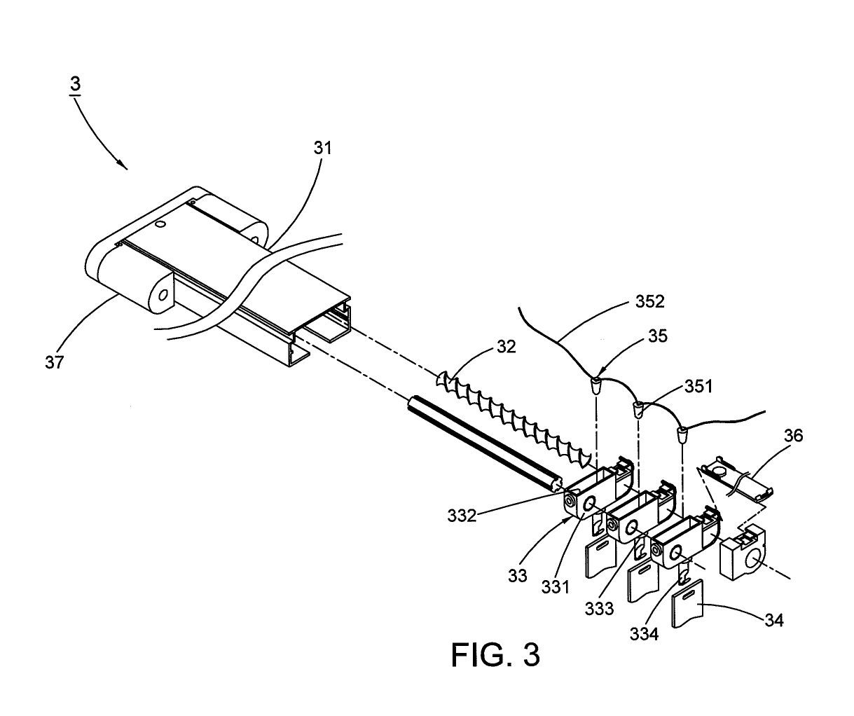

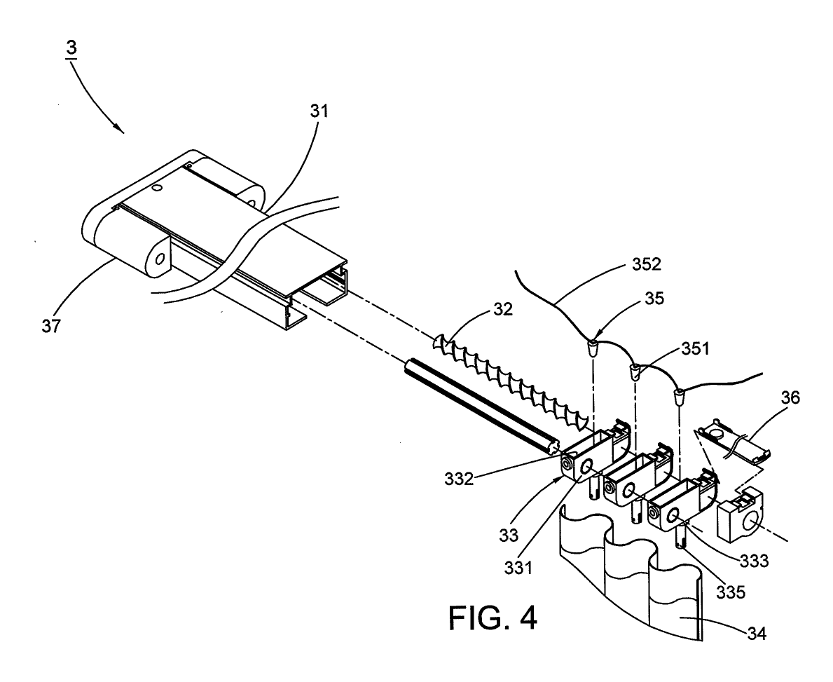

FIG. 3 shows a first preferred embodiment of a drape 3 with movable light sources comprising a bracket 31, a transmitting member 32 disposed on the bracket 31, at least one first moving member 33 triggered by the transmitting member 32, and a covering panel 34 installed on the first moving member 33. Wherein, a power source 37 is connected to the transmitting member 32 for motivating. Herein, the transmitting member 32 could be a transmitting belt, a worm shaft, etc. In this embodiment, the transmitting member 32 adopts a worm shaft. Each first moving member 33 has a first transmitting body 331 formed with a first receiving slot 332 and capable of moving within the bracket 31, and a first connecting unit 333 extended from the first receiving slot 332. A hook 334 is formed on the first connecting unit 333 for hanging the covering panel 34. The first connecting unit 333 could be alternatively formed with a claw 335 as shown in FIG. 4 for grasping the covering panel 34. In this embodiment and the following depiction, the hook 334 is adopted. As it should be, means for expanding the covering panel 34 is not limited, and the covering panel 34 could freely adopt vertical blinds or blinds; in the figure, the vertical blinds are adopted. Whereby, the vertical blinds are motivated by the transmitting member 32 and the first moving member 33 for sheltering, expanding, or swinging in angles.

Characterized in that, a light system 35 and a partition 36 are disposed in the bracket 31. Wherein, the partition 36 could freely adopt a ball chain or flake-like spacers as shown in the figure. Other forms of partition could be freely adopted while they are able to help the first moving members 33 shift equidistantly. Continuingly, the light system 35 has a light source 351 disposed in each first receiving slot 332 of the first moving member 33, and a connecting wire 352 connected to the light source 351 for electrifying. The first connecting unit 333 is pervious to light of the light source 351, and the light source 351 is synchronically moved along with the first moving member 33. Thus, the first moving member 33 is constrained by the partition 36 and accurately positioned within the bracket 31.

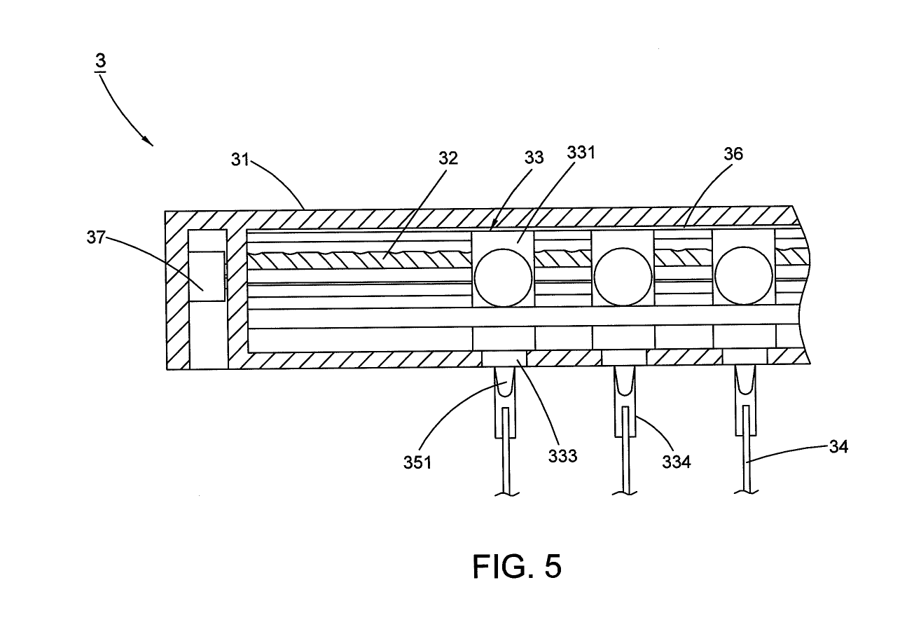

FIGS. 3 and 5 show the drape 3 of the present invention in operation. A remote control (not shown) is adopted for triggering the power source 37. Accordingly, the power source 37 motivates the transmitting member 32 so that the first moving member 33 and the covering panel 34 are influenced to achieve a sheltering operation, an expanding operation, or a swinging operation in different angles. Afore operations could be decided by users without restraint. When the first moving members 33 are thrust by the transmitting member 32, the partition 36 connected to the first moving members 33 synchronically restrains the movement of the first moving members 33, so that the first moving members 33 could move equidistantly. Thereby, the light source 351 simultaneously moves and emits light out of the first connecting unit 333. Preferably, each former partition 36 affects the follow-up partition by a tugging action when the former partition 36 is placed at a desired position. Therefore, the correlated first moving member 33 is correspondingly hauled and stopped in equidistance, so that the covering panel 34 hung thereon is succeedingly and accurately arranged on the bracket 31. In addition, by the first moving member 33 being provided with the light source 351 and the connecting wire 352 being connected to the light source 351, the motion of the covering panel 34 hung on the first moving member 33 also triggers the light source 351 and the connecting wire 352 concurrently. As a result, the light source 351 offers thorough and enhanced illumination on the covering panel 34. Thus, deficiency in the imprecise disposition of the light source existing in the conventional is solved. Namely, the fixed conventional light source is now movable for furnishing the extensive illuminating effect. Therefore, the drape 3 of the present invention presents a more artistic lighting performance. When the light source 351 is served at darkness or night, using convenience of the present invention is more introduced.

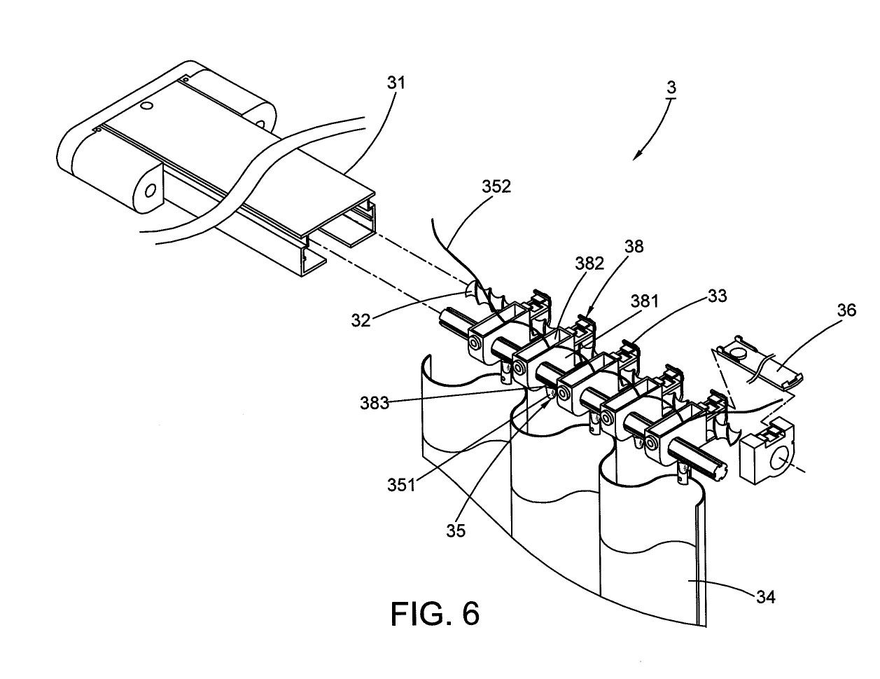

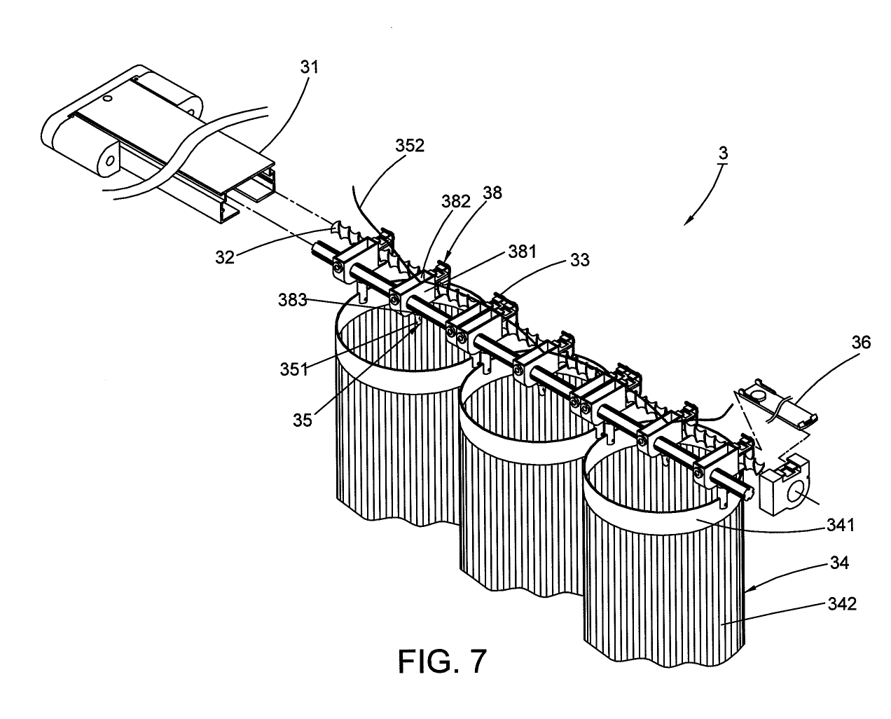

FIG. 6 shows a second preferred embodiment of the present invention. Herein, the bracket 31, the transmitting member 32, the first moving member 33, the covering panel 34, the light system 35, and the partition 36 are similarly included. Differently, a second moving member 38 is disposed between any two first moving members 33. The second moving member 38 does not connect to the covering panel 34. The second moving member 38 includes a second transmitting body 381 provided with a second receiving slot 382 and movable within the bracket 31, and a second connecting unit 383 extended from the second receiving slot 382, and the second connecting unit 383 is pervious to light of the light source 351. Further, the light source 351 could be installed in the first and second receiving slot 381, 382. Herein in the FIG. 7, only the light sources 351 positioned in the second removing member 38 emit light.

Further, the covering panel 34 includes a frame 341 and a panel body 342 fastened to a periphery of the frame 341. The frame 341 is grasped by any two first moving members 33, so that the expansion of the frame 341 allows the second moving member 38 to be justly positioned at a middle of the panel body 342. Whereby, the partition 36 similarly restrains the motion of the first moving member 33 in equidistance while the covering panel 34 is spread or drawn. Concurrently, the connecting wire 352 is dragged for concomitantly moving the light source 351. Therefore, when the covering panel 34 is properly positioned by the correlated motion of the first moving member 33, the frame 341 is unfolded. At the same time, the light source 351 on the second moving member 38 is preferably arranged for emitting light on the middle of the panel body 342. As a result, the drape 3 of the present invention gives an attractive lighting effect.

To sum up, the present invention takes advantages of the light system and the partition being both disposed within the bracket to allow the light source to move along with each first moving member. The movements of the first moving member and the covering panel are limited by the partition for accurately and equidistantly positioning on the bracket. Accordingly, when the covering panel is properly placed, the light source is justly arranged in accordance with the covering panel to provide light. Thus, the emitted light evenly spreads on the covering panel, which allows the drape to present an attractive appearance. When the light source is served at darkness or night, using convenience is further brought about.

Various modifications may be made in further embodiments described without departing from the spirit and scope of the invention.

I claim:

1. A drape with movable light sources comprising a bracket, a transmitting member disposed on said bracket, at least one first moving member triggered by said transmitting member, and a covering panel installed on said first moving member; each first moving member having a first transmitting body formed with a first receiving slot and capable of moving within said bracket, and a first connecting unit extended outward from said first receiving slot;
characterized in that, a light system and a partition are disposed in said bracket; said partition driving said first moving members to move in equidistance so as to allow said first moving members to be constrained thereby and positioned within said bracket; said light system having a light source disposed in each first receiving slot of said first moving member, and a connecting wire connected to said light source for electrifying; said first connecting unit being pervious to light of said first light source, and said light source being synchronically moved along with said first moving member.

2. The drape as claimed in claim 1, wherein, a second moving member is disposed between any two first moving members ; said second moving member is departed from said covering panel and has a second transmitting body provided with a second receiving slot and capable of moving within said bracket, and a second connecting unit extended outward from said second receiving slot; said light source is installed in said second receiving slot, and said second connecting unit is pervious to light of said light source.

3. The drape as claimed in claim 1, wherein, said first connecting unit is formed with a hook for hanging said covering panel.

4. The drape as claimed in claim 2, wherein, said first connecting unit is formed with a hook for hanging said covering panel.

5. The drape as claimed in claim 1, wherein, said first connecting unit is formed with a claw for grasping said covering panel.

6. The drape as claimed in claim 2, wherein, said first connecting unit is formed with a claw for grasping said covering panel.

7. The drape as claimed in claim 2, wherein, said covering panel includes a frame and a panel body fastened to a periphery of said frame; clipped by any two first moving members, said frame is expanded, allowing said second moving member to be justly positioned in a middle of said panel body.
